(19) United States
(12) Patent Application Publication
(10) Pub. No.: US 2002/0178876 A1
(43) Pub. Date: Dec. 5, 2002

(54) Electronic type torsional wrench

(76) Inventors: Nai-Jane Wang, Taichung City (TW); John Sun, Taichung City (TW)

Correspondence Address: CHARLES E. BAXLEY, ESQUIRE, Hart, Baxley, Daniels & Holton, 5th Floor, 59 John Street, New York, NY, 10038, US

(21) Appl. No.: 10/212,423

(22) Filed: Aug. 6, 2002

Related U.S. Application Data
(63) Continuation-in-part of application No. 09/859,366, filed on May 18, 2001.

(51) Int. Cl. B25B 23/14

(52) U.S. Cl. 81/467

(57) ABSTRACT

An electronic type torsional wrench includes a flexible member, a handle mounted on one end of the flexible member, and a sensor mounted between the flexible member and the handle. In such a manner, when a relative force is formed between the flexible member and the handle, the sensor detects the relative force or deformation, converts force or deformation values into torsion reading values, and displays the torsion reading values.

### CROSS-REFERENCES TO RELATED APPLICATIONS

The present invention is a continuation-in-part application of the co-pending U.S. Ser. No. 09/859,366, filed on May 18, 2001.

### BACKGROUND OF THE INVENTION

1. Field of the Invention

The present invention relates to an electronic type torsional wrench, and more particularly to an electronic type torsional wrench including an electronic sensor for detecting the torsion (or torque) of the wrench, and an electronic circuit for converting the bending values into torsion reading values.

2. Description of the Related Prior Art

A first conventional torsional wrench in accordance with the prior art shown in FIG. 1 comprises a stationary member 10 having a first end formed with a drive head 11 and a second end pivoted with a handle 14 by a pivot point 15, a torsion scale 13 secured on the stationary member 10 adjacent to the handle 14, and a pointer rod 12 integrally extended from the drive head 11 and having a free end pointed to the torsion scale 13. Under the normal state, the pointer rod 12 is in parallel with the stationary member 10.

In operation, the drive head 11 is fitted on a workpiece. The operator then exerts a force on the handle 14 to rotate the wrench and operate the workpiece. The handle 14 is pivoted with the stationary member 10 by the pivot point 15 so that the force in each direction exerted by the operator on the handle 14 can be concentrated on the pivot point 15 to be transmitted to the wrench. Thus, when the force applied on the wrench, the stationary member 10 deflects and form a relative angle with the pointer rod 12, so that the pointer 120 of the pointer rod 12 can indicate the torsion exerted on the wrench by the deflecting angle between the pointer rod 12 and the stationary member 10.

However, the first conventional torsional wrench has the following disadvantages.

1. The operator has to exert a torsional force on the handle successively so that the pointer of the pointer rod can read the torsion values. Thus, the torsion reading values are not accurately because the successive force applied by the operator is not even.

2. The pointer rod protrudes from the stationary member, so that it is easily hit, thereby affecting the accuracy thereof.

3. The operator has to exert a torsional force on the handle successively so that the pointer of the pointer rod can read the torsion values, thereby wasting the operator's energy.

A second conventional torsional wrench 16 in accordance with the prior art shown in FIG. 2 is disclosed in the Taiwanese Patent Publication No. 288375. The output torsion of the torsional wrench 16 is adjustable. When the force applied on the wrench exceeds a predetermined value, the wrench idles, thereby limiting the torsion exerted by the operator. However, the torsional wrench 16 cannot clearly indicate the torsion reading values.

### SUMMARY OF THE INVENTION

The present invention has arisen to mitigate and/or obviate the disadvantage of the conventional torsional wrenches.

The primary objective of the present invention is to provide an electronic type torsional wrench, comprising:

a stationary member;

a handle mounted on one end of the stationary member; and

a sensor mounted between the stationary member and the handle;

wherein, when a relative force is formed between the stationary member and the handle, the sensor detects the relative force or deformation, converts force or deformation values into torsion reading values, and displays the torsion reading values.

In accordance with one aspect of the present invention, there is provided an electronic type torsional wrench, comprising:

a drive shank having a first end formed with a drive head;

a torsion box secured on a second end of the drive shank;

a stationary member secured on the second end of the drive shank, and hidden in the torsion box;

a force applying stem having a first end secured in the torsion box, the force applying stem being deflected, and being moved relative to the stationary member; and

a sensor mounted between the stationary member and the force applying stem;

wherein, when a relative force or deformation is formed between the stationary member and the force applying stem, the sensor detects the relative force or deformation, converts force values into torsion reading values, and displays the torsion reading values.

In accordance with another aspect of the present invention, there is provided an electronic type torsional wrench, comprising:

a stationary member having a first end formed with a drive head;

a torsion box secured on the drive head of the stationary member, with the stationary member being hidden in the torsion box;

a force applying stem having a first end secured in the torsion box, the force applying stem being deflected, and being moved relative to the stationary member; and

a sensor mounted between the stationary member and the force applying stem;

wherein, when a relative force or deformation is formed between the stationary member and the force applying stem, the sensor detects the relative force or deformation, converts force or deformation values into torsion reading values, and displays the torsion reading values.

Further benefits and advantages of the present invention will become apparent after a careful reading of the detailed description with appropriate reference to the accompanying drawings.

### BRIEF DESCRIPTION OF THE DRAWINGS

FIG. 1 is a top plan schematic view of a first conventional torsional wrench in accordance with the prior art;

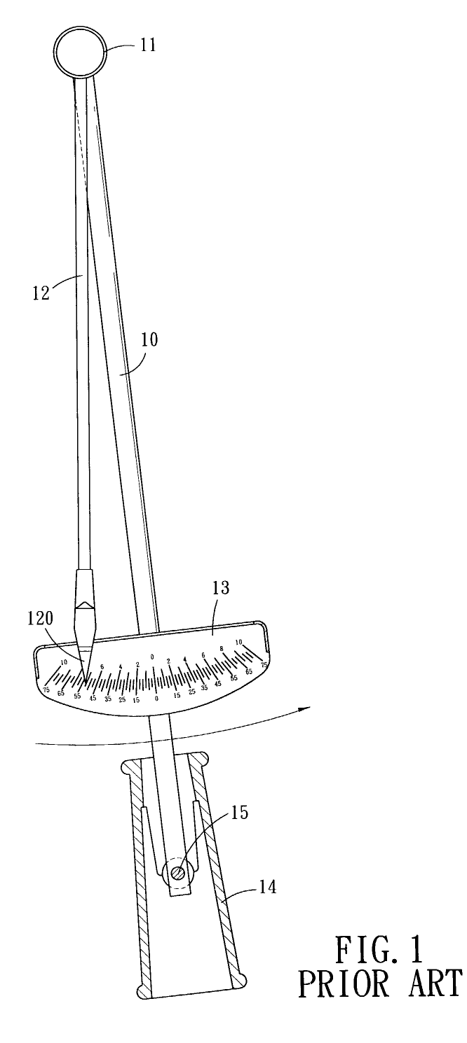

FIG. 2 is a perspective view of a second conventional torsional wrench in accordance with the prior art;

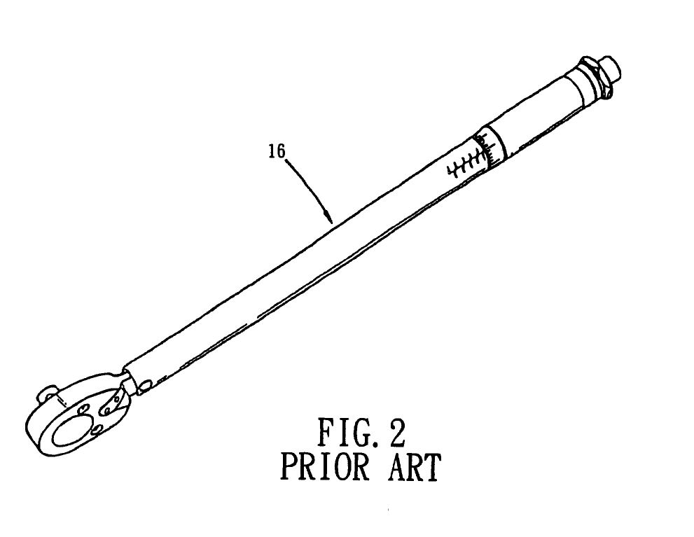

FIG. 3 is a perspective view of an electronic type torsional wrench in accordance with a first embodiment of the present invention;

FIG. 4 is a partially cut-away plan cross-sectional view of the electronic type torsional wrench as shown in FIG. 3;

FIG. 5 is a top plan view of an electronic type torsional wrench in accordance with a second embodiment of the present invention;

FIG. 6 is a cross-sectional view of the electronic type torsional wrench as shown in FIG. 3; and

FIG. 7 is a front plan cross-sectional view of the electronic type torsional wrench in accordance with the second embodiment of the present invention.

### DETAILED DESCRIPTION OF THE INVENTION

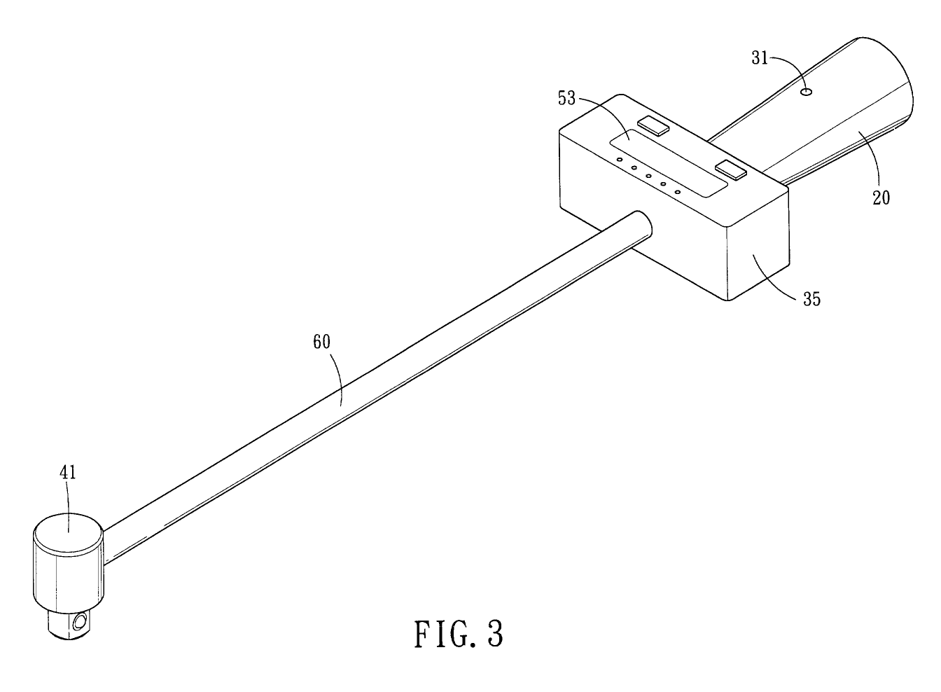

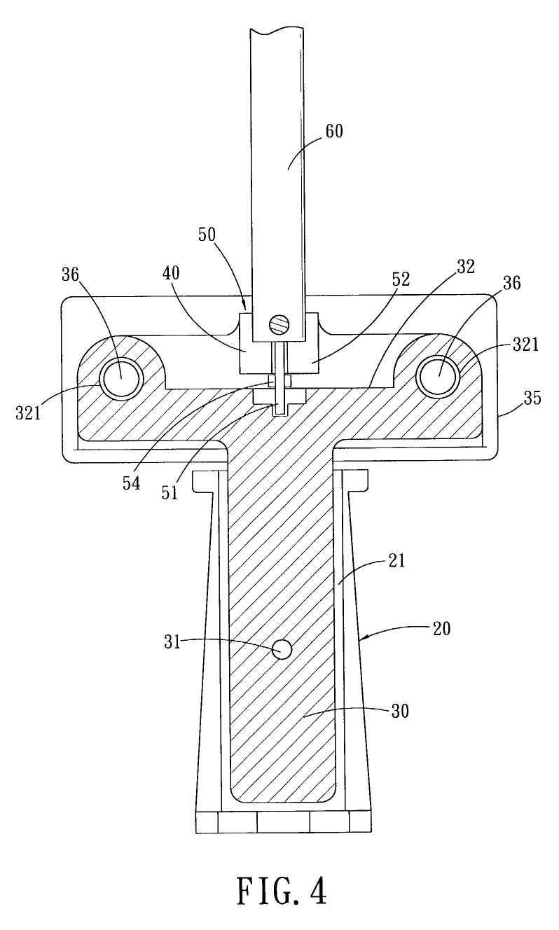

Referring to the drawings and initially to FIGS. 3 and 4, an electronic type torsional wrench in accordance with a first embodiment of the present invention comprises a handle 20, a force applying stem 30, a torsion box 35, a stationary member 40, a sensor 50, and a drive shank 60.

The operator may hold the handle 20 to exert a force on the handle 20. The handle 20 has an inside formed with a hollow receiving chamber 21. The drive shank 60 has a first end formed with a drive head 41 such as a socket head, a wrench head or the like. The torsion box 35 is secured on a second end of the drive shank 60. The stationary member 40 is secured on the second end of the drive shank 60, and is hidden in the torsion box 35.

The force applying stem 30 has a first end secured in the torsion box 35, and a second end mounted in the receiving chamber 21 of the handle 20. The first end of the force applying stem 30 is formed with a combination portion 32. The combination portion 32 of the force applying stem 30 is formed with two combination points 321. The torsion box 35 is formed with a connecting portion 36 combined with the two combination points 321 of the combination portion 32 of the force applying stem 30, so that the first end of the force applying stem 30 is secured in the torsion box 35.

A pivot shaft 31 is in turn extended through the handle 20 and the force applying stem 30, so that the handle 20 is pivotally mounted on the force applying stem 30. Thus, when the operator exerts a force on the handle 20, the force directed toward each direction exerted by the operator on the handle 20 may be concentrated on the pivot shaft 31 and may be transmitted to the second end of the force applying stem 30, so that the force applying stem 30 may be deflected to twist and deform the force applying stem 30, and may be moved relative to the stationary member 40.

The sensor 50 is mounted between the stationary member 40 and the force applying stem 30, and includes a fixed seat 52, a flexible member 51, a detecting member 54, a converting unit, and a display monitor 53. The fixed seat 52 of the sensor 50 is formed on a distal end of the stationary member 40. The flexible member 51 of the sensor 50 is secured on the first end of the force applying stem 30 to move therewith, and is flexible relative to the fixed seat 52. The detecting member 54 of the sensor 50 is mounted on a distal end of the flexible member 51 to move therewith.

In operation, when the operator exerts a force on the handle 20, the force may be transmitted to the second end of the force applying stem 30, so that the force applying stem 30 may be deflected to twist and deform the force applying stem 30, and may be moved relative to the stationary member 40. Thus, the flexible member 51 of the sensor 50 is bent with the force applying stem 30 to deform the detecting member 54, so that the detecting member 54 may be urged and compressed between the flexible member 51 and the fixed seat 52. Then, the force exerted on the detecting member 54 may be converted into torsion reading values by the converting unit (the converting unit may be a circuit converting unit), and the torsion reading values are displayed by the display monitor 53 in various numbers.

By such an arrangement, when a relative force is formed between the flexible member 51 and the fixed seat 52, that is, when a relative force is formed between the force applying stem 30 and the stationary member 40, the sensor 50 detects the force values which are converted into torsion reading values by the converting unit, and the torsion reading values are displayed by the display monitor 53 in various numbers.

It is appreciated that, the torsional wrench in accordance with the present invention primarily employs the “variation of force” between the force applying stem 30 and the stationary member 40 (or between the flexible member 51 and the fixed seat 52) to serve as value detection, so that the torsional wrench can obtain accurate detecting values.

In use, the operator may directly read the torsion reading values from the display monitor 53. When the torsion reading values are detected, the data of the torsion reading values are indicated on the display monitor 53, so that the operator needs not to exert the force successively. In addition, the operator can preset the torsion values through the design of a circuit, so that when the torsional wrench is rotated to reach the predetermined torsion value, the sensor 50 not only displays the reading values through the display monitor 53, but also informs the operator that the predetermined torsion value has been reached by means of blink of light signals or by audio signals, so that the operation is convenient.

According to the torsional wrench of the present invention, the force applying stem 30 and the stationary member 40 are respectively combined with the flexible member 51 and the fixed seat 52 of the sensor 50. Thus, when the relative force is formed between the force applying stem 30 and the stationary member 40, the sensor 50 detects the force or deformation values which are converted into torsion reading values by the converting unit, and the torsion reading values are displayed by the display monitor 53. Therefore, the torsion reading values can be detected accurately, and the operation of the torsional wrench is very convenient.

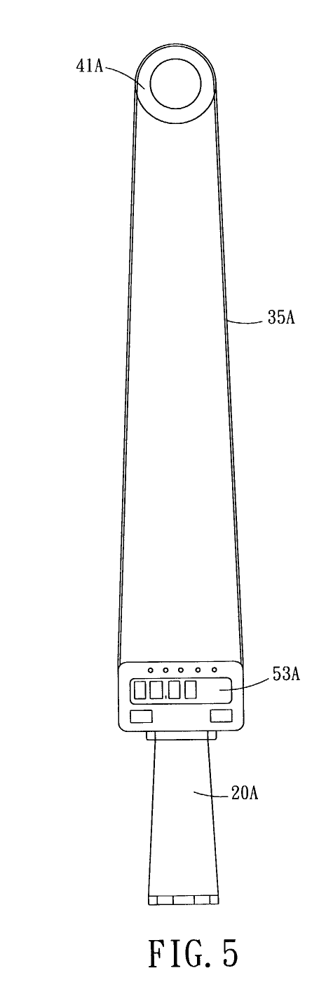

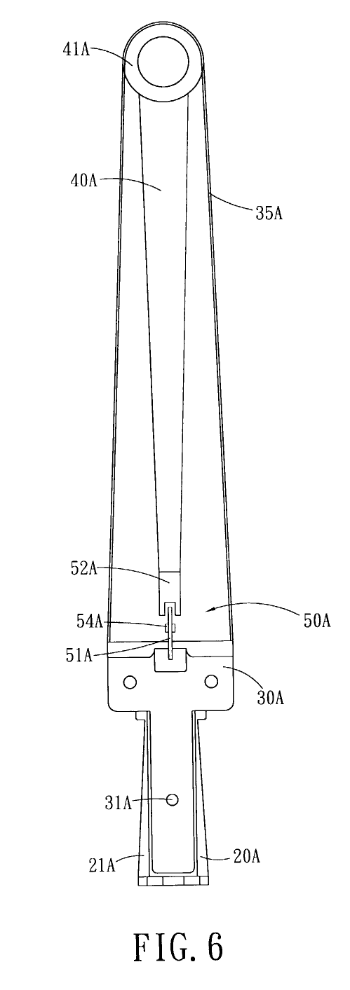

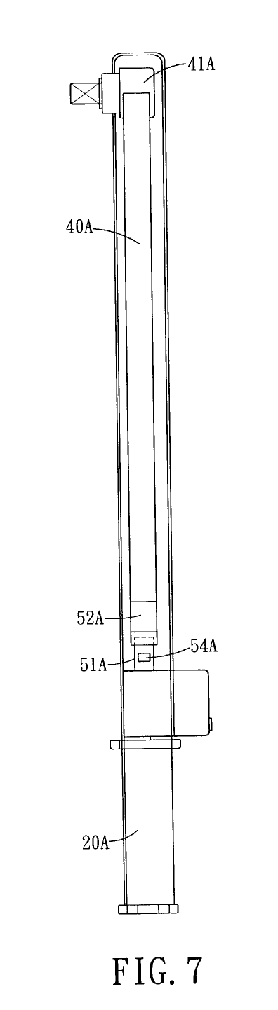

Referring to FIGS. 5-7, an electronic type torsional wrench in accordance with a second embodiment of the present invention comprises a handle 20A, a force applying stem 30A, a torsion box 35A, a flexible member 40A, and a sensor 50A.

The operator may hold the handle 20A to exert a force on the handle 20A. The handle 20A has an inside formed with a hollow receiving chamber 21A. The flexible member 40A has a first end formed with a drive head 41A such as a socket head, a wrench head or the like. The torsion box 35A is secured on the drive head 41A of the flexible member 40A, with the flexible member 40A being hidden in the torsion box 35A. The force applying stem 30A has a first end secured in the torsion box 35A, and a second end mounted in the receiving chamber 21A of the handle 20A.

A pivot shaft 31A is in turn extended through the handle 20A and the force applying stem 30A, so that the handle 20A is pivotally mounted on the force applying stem 30A. Thus, when the operator exerts a force on the handle 20A, the force directed toward each direction exerted by the operator on the handle 20A may be concentrated on the pivot shaft 31A and may be transmitted to the second end of the force applying stem 30A, so that the force applying stem 30A may be twist and deform the drive head 41A, and may be bent the flexible member 40A.

The sensor 50A is mounted between the flexible member 40A and the force applying stem 30A. The tensile sensor 50A is secured on the first end of the force applying stem 30A to move therewith. The detecting member 54A is mounted on the flexible member 51A to move therewith.

In operation, when the operator exerts a force on the handle 20A, the force may be transmitted to the second end of the force applying stem 30A, so that the force applying stem 30A may be deflected to twist and deform the drive head 41A, and may be twist relative to the torsion box 35A. Thus, the flexible member 51A is bent due to the tip of the flexible member 40A deflected and the flexible member 51A exerted on the detecting member 54A, so that the detecting member 54A may be urged and compressed between the flexible member 51A and the seat 52A. Then, the force exerted on the detecting member 54A may be converted into torsion reading values by the converting unit (the converting unit may be a circuit converting unit), and the torsion reading values are displayed by the display monitor 53A in various numbers.

By such an arrangement, when a relative force is formed between the flexible member 51A and the seat 52, that is, when a relative force is formed between the force applying stem 30A and the flexible member 40A, the detecting member 54A detects the force or deformation values which are converted into torsion reading values by the converting unit, and the torsion reading values are displayed by the display monitor 53A in various numbers.

It is appreciated that, the torsional wrench in accordance with the present invention primarily employs the “variation of force” between the force applying stem 30A and the flexible member 40A (or between the flexible member 51A and the seat 52A) to serve as value detection, so that the torsional wrench can obtain accurate detecting values.

In use, the operator may directly read the torsion reading values from the display monitor 53A. When the torsion reading values are detected, the data of the torsion reading values are indicated on the display monitor 53A, so that the operator needs not to exert the force successively. In addition, the operator can preset the torsion values through the design of a circuit, so that when the torsional wrench is rotated to reach the predetermined torsion value, the detecting member 54A not only displays the reading values through the display monitor 53A, but also informs the operator that the predetermined torsion value has been reached by means of blink of light signals or by audio signals, so that the operation is convenient.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. An electronic type torsional wrench, comprising:
a stationary member;
a handle mounted on one end of the stationary member; and
a sensor mounted between the stationary member and the handle;
wherein, when a relative force or deformation is formed between the stationary member and the handle, the sensor detects the relative force or deformation, converts force or deformation values into torsion reading values, and displays the torsion reading values.

2. An electronic type torsional wrench, comprising:
a drive shank having a first end formed with a drive head;
a torsion box secured on a second end of the drive shank;
a stationary member secured on the second end of the drive shank, and hidden in the torsion box;
a force applying stem having a first end secured in the torsion box, the force applying stem being deflected, and being moved relative to the stationary member; and
a sensor mounted between the stationary member and the force applying stem;
wherein, when a relative force or deformation is formed between the stationary member and the force applying stem, the sensor detects the relative force or deformation, converts force or deformation values into torsion reading values, and displays the torsion reading values.

3. The electronic type torsional wrench in accordance with claim 2, further comprising a handle pivotally mounted on a second end of the force applying stem.

4. The electronic type torsional wrench in accordance with claim 3, further comprising a pivot shaft in turn extended through the handle and the second end of the force applying stem, so that the handle is pivotally mounted on the second end of the force applying stem.

5. The electronic type torsional wrench in accordance with claim 2, wherein the first end of the force applying stem is formed with a combination portion which is formed with two combination points, and the torsion box is formed with a connecting portion combined with the two combination points of the combination portion of the force applying stem, so that the first end of the force applying stem is secured in the torsion box.

6. The electronic type torsional wrench in accordance with claim 2, wherein the sensor includes a seat, and a flexible member, the seat is formed on a end of the flexible member, a flexible member is secured on the first end of the force applying stem to move therewith, and a detecting member is mounted on the flexible member to move therewith.

7. The electronic type torsional wrench in accordance with claim 2, wherein the sensor further includes a display monitor.

8. An electronic type torsional wrench, comprising:
a flexible member having a first end formed with a drive head;
a torsion box secured on the drive head of the flexible member, with the flexible member being hidden in the torsion box;
a force applying stem having a first end secured in the torsion box, the force applying stem being deflected to bend the flexible member; and
a sensor mounted between the flexible member and the force applying stem;
wherein, when a relative force or deformation is formed between the flexible member and the force applying stem, the sensor detects the relative force or deformation, converts force or deformation values into torsion reading values, and displays the torsion reading values.

9. The electronic type torsional wrench in accordance with claim 8, further comprising a handle pivotally mounted on a second end of the force applying stem.

10. The electronic type torsional wrench in accordance with claim 9, further comprising a pivot shaft in turn extended through the handle and the second end of the force applying stem, so that the handle is pivotally mounted on the second end of the force applying stem.

11. The electronic type torsional wrench in accordance with claim 8, wherein the sensor includes a seat, a flexible member, and a detecting member, the seat is formed on a distal end of the flexible member, the flexible member of the sensor is secured on the first end of the force applying stem to move therewith, and is movable relative to the seat, and the detecting member of the sensor is mounted on the flexible member to move therewith.

12. The electronic type torsional wrench in accordance with claim 8, wherein the sensor further includes a display monitor.
